(19) United States
(12) Patent Application Publication
(10) Pub. No.: US 2006/0208734 A1
(43) Pub. Date: Sep. 21, 2006

(54) Magnetic resonance reception coil composite structure

(76) Inventors: Ting Qiang Xue, Shenzhen (CN); Jian Min Wang, Shenzhen (CN); Yan Hong Chen, Shenzhen (CN)

Correspondence Address: SCHIFF HARDIN, LLP;PATENT DEPARTMENT, 6600 SEARS TOWER, CHICAGO, IL, 60606-6473, US

(21) Appl. No.: 11/363,923

(22) Filed: Feb. 28, 2006

(30) Foreign Application Priority Data
Feb. 28, 2005 (CN) 200520004982.8

(51) Int. Cl. G01V 3/00

(52) U.S. Cl. 324/318

(57) ABSTRACT

A magnetic resonance reception coil composite structure is formed by at least one rigid subassembly and at least one flexible subassembly that are connected to each other. The rigid subassembly and the flexible subassembly each include an inner conductor layer, and the inner conductor layer of the rigid subassembly and the inner conductor layer of the flexible subassembly are electrically connected. Different combinations of the rigid subassembly and the flexible subassembly can be used in multiple configurations, so that the magnetic resonance reception coil can achieve complicated shapes to meet the requirements for use at the different sites of a patient, while being comfortable and endurable for the patient.

### BACKGROUND OF THE INVENTION

1. Field of the Invention

The present invention relates to a magnetic resonance reception coil structure and, in particular, to a composite structure of a magnetic resonance reception coil.

2. Description of the Prior Art

A magnetic resonance imaging device is typically used in imaging diagnosis for different sites of the patient, and thus needs different types of reception coils, such as a limb and trunk coil, a shoulder coil, a cervical vertebrae coil, a wrist coil and the like.

Considering the structure and the shape, the reception coil should meet the following requirements:

1) the inner cavity of the coil should correspond with the shape of the site to be tested as closely as possible to achieve a relatively high fill factor and to improve the signal to noise ratio, thereby achieving high imaging quality;

2) in accordance with the principles of ergonomics, the coil should be comfortable for a patient to be in contact with the coil for a long period of time;

3) The could should be light enough to be positioned and removed easily;

4) the material used for the coil should not affect imaging quality.

These requirements mean requires that a magnetic resonance reception coil of the above type (also referred to as a surface coil or a local coil) should make use of special materials, and have a different shape and structure, to meet these requirements at different sites relative to the patient.

Magnetic resonance reception coils are now classified into two broad classes—rigid coils and flexible coils—depending on their structure.

The outer housing of a rigid coil is typically a hard plastic structure, and is manufactured by shaping processes such as injection molding or resin casting, with an inner conductor layer provided within the hard plastic structure. The advantages of the rigid coil are accurate shape and reliable use.

Since the outer housing of the rigid coil can be made into various complicated shapes, for many different sites to be imaged, easy and flexible positioning and removal is possible by using a connecting member specially designed and disposed therein. The structure of the rigid coil lacks adaptability, however, because the structure cannot change once it has been shaped, so it is hard to ensure comfort and endurance for certain sites of particular shape and structure. Moreover, it is difficult to be positioned and removed relative to certain sites.

The outer housing of the flexible coil is made with elastic polymers, such as artificial elastic, plastic compound or foam plastics, and can be shaped using the processes of injection molding, casting, hot pressing and the like, and can also be sewed using synthetic leather or natural leather as an envelope.

The biggest advantages of the flexible coil are flexible use and comfort and endurance for a patient, but the desired materials and manufacturing process thereof are relatively special. The inner conductor layer (copper sheet and insulating film) that constitutes the flexible coil loop is typically predisposed within the die as an embedded member, so it is difficult to achieve accurate positioning for a coil of complicated shape. Therefore, the appearance of the flexible coil is typically a relatively regular shape, such as a sheet, band, ring and the like.

FIG. 1 shows a conventional type of a flexible coil 200 with a band structure. The flexible coil 200 is used to enclose the site of the patient to be tested, and its band structure ensures that it is in tight contact with the site to be tested, thereby ensuring the imaging quality. As mentioned above, however, since the inner conductor layer needs to be pre-embedded within the flexible coil, to secure accurate positioning, it has a relatively simple shape.

Thus, there is a need in the field of manufacturing magnetic resonance reception coils to provide a complicated shape to meet the requirements for use at different sites of a patient and while providing a magnetic resonance reception coil structure that is comfortable and endurable for a patient.

### SUMMARY OF THE INVENTION

An object of the present invention is to provide a magnetic resonance reception coil composite structure that has a complicated shape to meet the requirements for use at different sites of a patient, which also is meanwhile provides comfortable and endurable for a patient.

This object is achieved in accordance with the present invention by a magnetic resonance reception coil composite structure formed into a cubic, spatial, non-planar, irregular complicated structure by at least one rigid subassembly and at least one flexible subassembly which are connected to each other. The rigid subassembly and the flexible subassembly each include an inner conductor layer, and the inner conductor layer of the rigid subassembly and the inner conductor layer of the flexible subassembly are electrically connected.

The rigid subassembly includes a first housing and a second housing, the first housing being integrated with the second housing to form the rigid subassembly. The first housing and the second housing each form a cavity, and the respective cavities form a reception space when the first housing and the second housing are assembled together. The inner conductor layer of the rigid subassembly is received within said reception space. The first housing is integrated with the second housing by any of screw fastening, clamping, bonding and ultrasonic welding. The rigid subassembly is a hard plastic structure. The flexible subassembly further includes a flexible outer covering, and the inner conductor layer of the flexible subassembly is wrapped within the flexible outer covering. A number of grooves of suitable depth are provided on the surface of the flexible outer covering of the flexible subassembly. The rigid subassembly and the flexible subassembly are connected together by any of clamping, insertion, screwing and bonding. The inner conductor layers of the rigid subassembly and the flexible subassembly are connected together by any of welding, riveting, a circlip and screws, thereby effecting an electrical connection.

The magnetic resonance reception coil composite structure of the present invention utilizes a suitable combination of the rigid subassembly and the flexible subassembly so that the magnetic resonance reception coil can provide complicated shapes to meet the requirements for use at different sites of a patient while being comfortable and endurable for a patient.

### DESCRIPTION OF THE DRAWINGS

FIG. 1 is a schematic view of a flexible coil of the prior art.

FIG. 2 is a schematic view of an embodiment of a magnetic resonance reception coil composite structure according to the present invention.

FIG. 3A and FIG. 3B are schematic sectional views showing the connection manners of the rigid subassemblies of the magnetic resonance reception coil composite structure of the present invention, respectively.

FIG. 4 is a schematic sectional view of an embodiment of the flexible subassembly of the magnetic resonance reception coil composite structure of the present invention.

FIG. 5 is an embodiment of the flexible subassembly of the magnetic resonance reception coil composite structure of the present invention.

FIG. 6 is another embodiment of the flexible subassembly of the magnetic resonance reception coil composite structure of the present invention.

FIGS. 7A, 7B, 7C and 7D are schematic sectional views showing the connection manners of the rigid subassemblies and the flexible rigid subassemblies of the magnetic resonance reception coil composite structure of the present invention, respectively.

FIG. 8 is a schematic sectional view showing the connection manner of the inner conductor layers of the rigid subassembly and the flexible rigid subassembly of the magnetic resonance reception coil composite structure of the present invention.

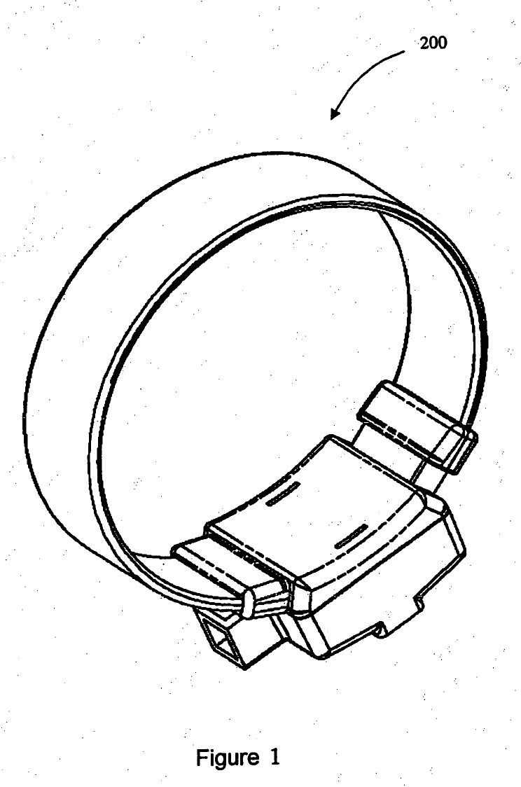

### DESCRIPTION OF THE PREFERRED EMBODIMENTS

In FIG. 2, an embodiment of the magnetic resonance reception coil composite structure of the present invention is illustrated. This embodiment is described using a shoulder coil as an example, but it will be understood that the magnetic resonance reception coil composite structure of the present invention is not limited thereto, and coils that are applicable to other sites of the patient, and having the same technical features described herein, are encompasses within the inventive concept.

As shown in FIG. 2, the magnetic resonance reception coil composite structure 100 includes a number of rigid subassemblies 10, 50 and a number of flexible subassemblies 20, 30, 40, 60. The rigid subassemblies 10, 50 form the main body of the magnetic resonance reception coil composite structure, and the flexible subassemblies 20, 30, 40, 60 form connecting parts of the magnetic resonance reception coil composite structure. It will be understood that at least one rigid subassembly and at least one flexible subassembly are needed to form the magnetic resonance reception coil composite structure 100 of the present invention.

The outer housings of such rigid subassemblies 10, 50 are hard plastic structures which are manufactured by shaping processes such as injection molding, plastic molding or resin casting and the like, and the shape of which may be planar or curved, depending on its position within the coil. Such rigid subassemblies 10, 50 each have a first housing and a second housing which can be integrated by means of screw fastening, clamping, bonding, ultrasonic welding and the like. An inner conductor layer (copper sheet and insulating film) which is used to form a coil loop is installed within such rigid subassemblies 10, 50. In another embodiment of the present invention, such rigid subassemblies 10, 50 can be formed of blocks that can be integrated together.

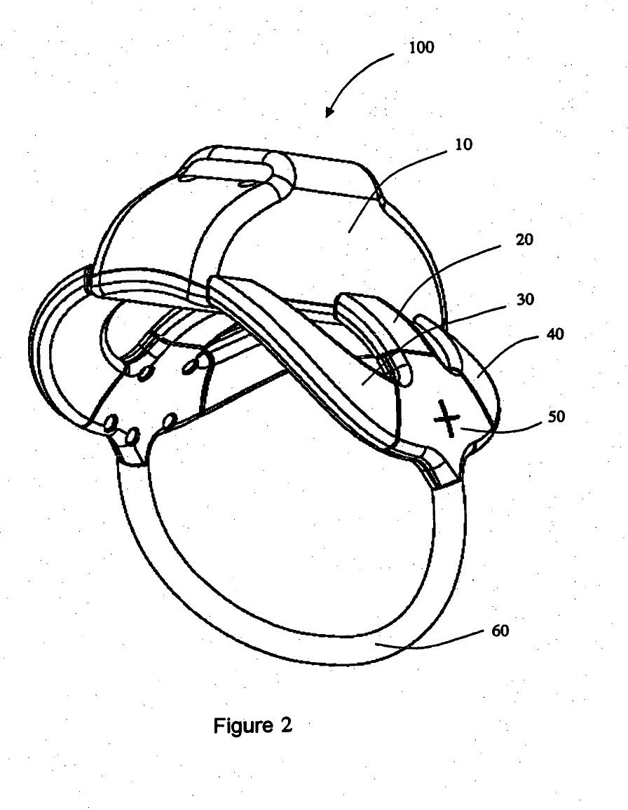

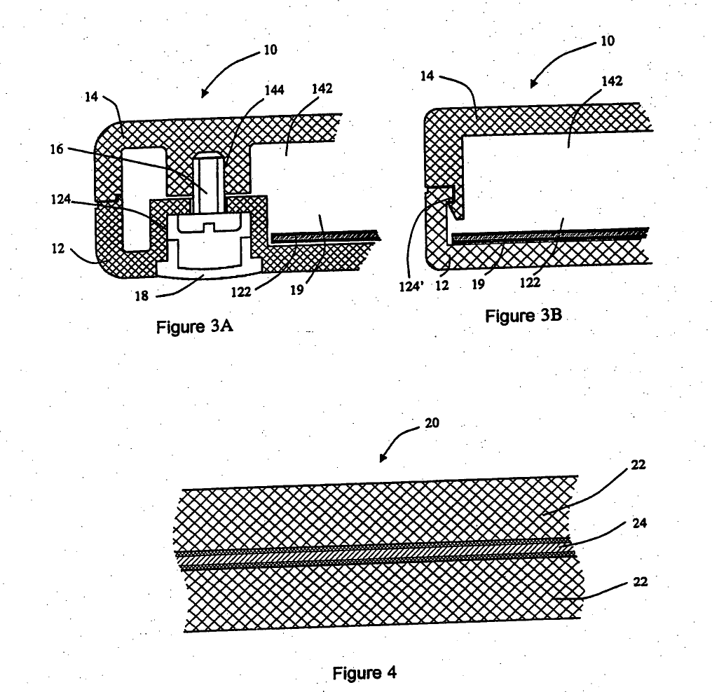

With reference to FIG. 3A and FIG. 3B, there are many types of connections between parts of such rigid subassemblies 10, 50. FIG. 3A and FIG. 3B respectively illustrate two connections of screw fastening and clamping, using the rigid subassembly 10 as an example. Since the connection of the rigid subassembly 50 is similar to that of the rigid subassembly 10, it is only described herein as an example, and should not be considered as being limited to, the rigid subassembly 10.

With reference to FIG. 3A, the rigid subassembly 10 includes a first housing 12 and a second housing 14. The interior of the first housing 12 forms a cavity 122, and a stepped counter-bore 124 is provided in a suitable position. The interior of the second housing 14 also forms a cavity 142, and a screw-hole 144 is provided in a suitable position. A screw 16 passes through the counter-bore 124 of the first housing 12, and is locked within the screw-hole 144 of the second housing 14, thereby securing the first housing 12 and the second housing 14 together. For a better overall appearance, a cover 18 is further provided on the counter-bore 124 of the first housing 12 to cover the counter-bore 124. The cavity 122 of the first housing 12 and the cavity 142 of the second housing 14 together form a receiving space to receive an inner conductor layer 19.

With reference to FIG. 3B, in another embodiment of the present invention, the interior of the first housing 12 forms a cavity 122, and the ends of the side edges thereof form a bayonet portion 124′. The interior of the second housing 14 also forms a cavity 142, and the ends of the side edges thereof form a flange 144′ which corresponds to the bayonet portion 124′ of the first housing 12. The flange 144′ of the second housing 14 may correspond to the bayonet portion 124′ of the first housing 12, so that the first housing 12 and the second housing 14 are locked together. The cavity 122 of the first housing 12 and the cavity 142 of the second housing 14 together form a receiving space to receive an inner conductor layer 19.

The flexible outer coverings of the flexible subassemblies 20, 30, 40, 60 are made of elastic polymers, such as artificial elastic plastic compound or foam plastics, and can be shaped using processes of injection molding, casting, hot pressing and the like, and can also be sewed together encompassed by synthetic leather or natural leather, which acts as an envelope, and the inner conductor layer (copper sheet and insulating film) which constitutes the coil loop is laid therein.

With reference to FIG. 4, a typical structure of the flexible subassembly of the present embodiment is illustrated, using the flexible subassembly 20 as an example. Since the structures of the other rigid subassemblies 30, 40, 60 are similar to that of the flexible subassembly 20, it is only described herein as a non-limiting example, using the rigid subassembly 10. In FIG. 4, the inner conductor layer 24 of the flexible subassembly 20 is wrapped within the flexible outer covering 22. The shape of the flexible subassembly 20 may be a plane, a regularly curved surface or irregular curved surface, depending on its position within the coil. Because of the relative small breadth and the small radius curved surface, even though the shapes thereof are irregular curved surfaces, the inner conductor layer 24 (copper sheet and insulating film) may be positioned precisely and be maintained, and this can be achieved by simple apparatuses and processes.

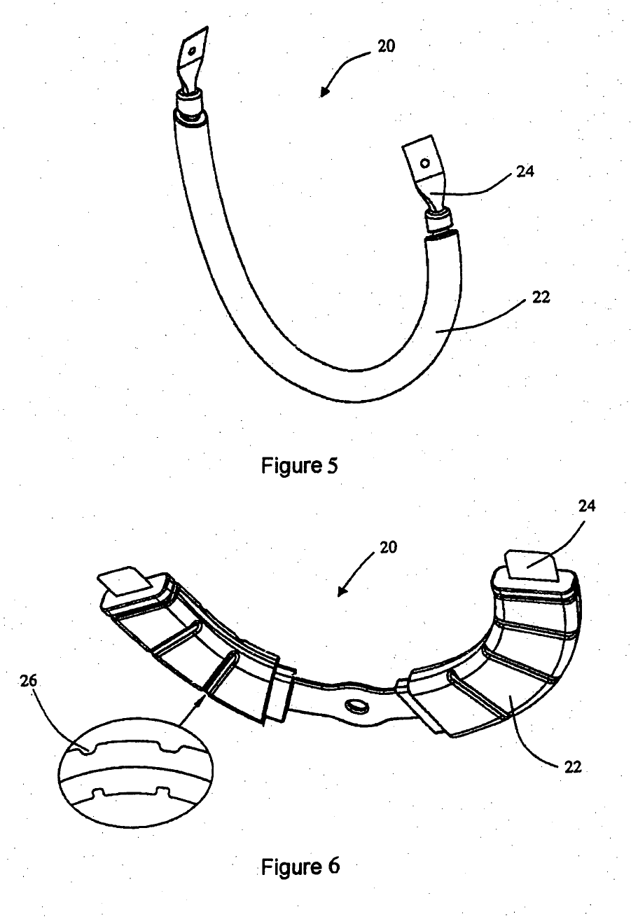

With reference to FIG. 5 and FIG. 6, two common types of structures of the flexible subassembly 20 are illustrated. In FIG. 5, the flexible subassembly 20 is in the shape of a flexible tube, and the inner conductor layer 24 is wrapped within the flexible outer covering 22. In FIG. 6, the flexible subassembly 20 is in the shape of a square and flat band, and the inner conductor layer 24 is wrapped within the flexible outer covering 22. Grooves 26 which are of suitable depth and are arranged in the same direction or different directions may be provided on the inner surfaces and/or the outer surfaces of the flexible subassembly 20, so that it makes it easier for the flexible subassembly 20 to deform, thereby achieving the desired curved shape.

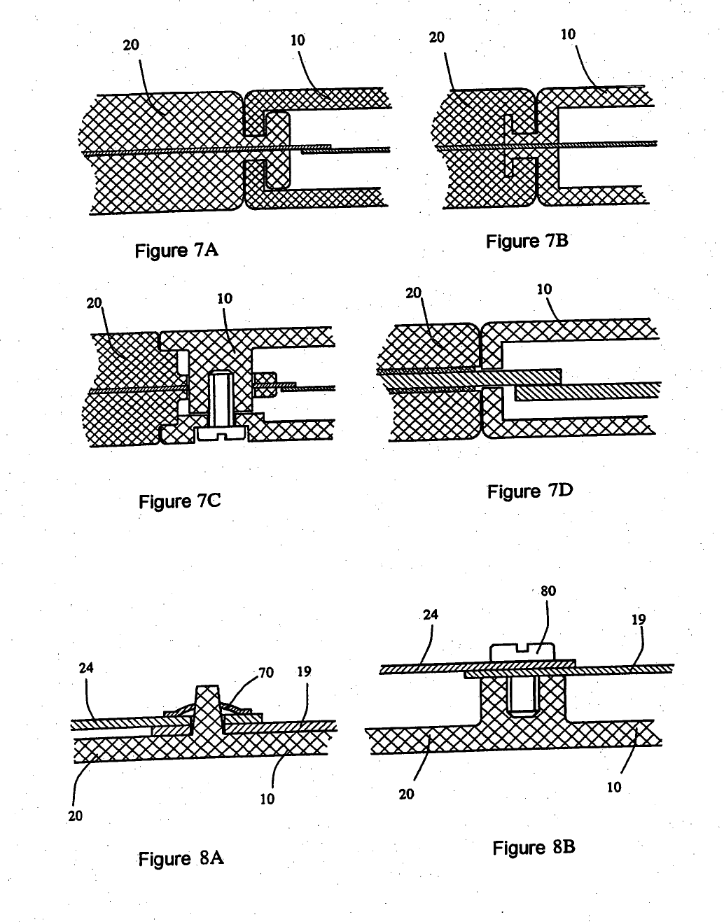

With reference to FIG. 7A to FIG. 7D, several common types of connections between the rigid subassembly 10 and the flexible subassembly 20 of the magnetic resonance reception coil composite structure 100 of the present invention are illustrated, using the connection between the rigid subassembly 10 and the flexible subassembly 20 as an example.

With reference to FIG. 7A, the rigid subassembly 10 is connected with the flexible subassembly 20 by means of clamping. One end of the rigid subassembly 10 clamps one end of the flexible covering of the flexible subassembly 20 to produce an elastic deformation therein, and clamp the same between the outer end portion of the rigid subassembly 10 and the receiving space, thereby effecting the connection between the rigid subassembly 10 and the flexible subassembly 20.

With reference to FIG. 7B, the rigid subassembly 10 is connected with the flexible subassembly 20 by means of inlaying. One end of the rigid subassembly 10 is inserted in one end of the flexible covering of the flexible subassembly 20, thereby effecting the connection between the rigid subassembly 10 and the flexible subassembly 20.

With reference to FIG. 7C, the rigid subassembly 10 is connected with the flexible subassembly 20 by means of screw fastening. One end of the rigid subassembly 10 and one end of the flexible subassembly 20 are lapped and the lapped portions are secured by a screw, thereby effecting the connection between the rigid subassembly 10 and the flexible subassembly 20.

With reference to FIG. 7D, the rigid subassembly 10 is connected with the flexible subassembly 20 by means of bonding. One end of the rigid subassembly 10 is secured to one end of the flexible subassembly 20 by glue, thereby effecting the connection between the rigid subassembly 10 and the flexible subassembly 20.

The inner conductor layers (copper sheet and insulating film) of the rigid subassembly and the flexible subassembly can be electrically connected by suitable means, such as welding, riveting, a circlip, screws and the like, to form an entire loop. With reference to FIGS. 8A and 8B, several common types of connections between the inner conductor layers of the rigid subassembly and the flexible subassembly of the magnetic resonance reception coil composite structure 100 of the present invention are illustrated respectively, taking the connection between the rigid subassembly 10 and the flexible subassembly 20 as an example.

With reference to FIG. 8A, one end of the inner conductor layer 19 of the rigid subassembly 10 and one end of the inner conductor layer 24 of the flexible subassembly 20 are overlapped, and a circlip 70 is provided on the overlapped portion and presses against the overlapped portion, so that the inner conductor layer 19 of the rigid subassembly 10 is in contact with and thus electrically connected to the inner conductor layer 24 of the flexible subassembly 20.

With reference to FIG. 8B, one end of the inner conductor layer 19 of the rigid subassembly 10 and one end of the inner conductor layer 24 of the flexible subassembly 20 are overlapped, and a screw 80 passes through the overlapped portion and secures the overlapped portion, so that the inner conductor layer 19 of the rigid subassembly 10 is in contact with and thus electrically connected to the inner conductor layer 24 of the flexible subassembly 20.

As mentioned above, the magnetic resonance reception coil composite structure of the present invention utilizes a suitable combination of the rigid subassembly and the flexible subassembly so that the magnetic resonance reception coil can achieve complicated shapes to meet the requirements for use at the different sites of a patient, and are comfortable and endurable for a patient.

Although modifications and changes may be suggested by those skilled in the art, it is the intention of the inventors to embody within the patent warranted hereon all changes and modifications as reasonably and properly come within the scope of their contribution to the art.

We claim as our invention:

1. A magnetic resonance reception coil comprising:
at least one rigid subassembly and at least one flexible subassembly connected to each other; and
said at least one rigid subassembly and said at least one flexible subassembly each including an interior conductor layer, the interior conductor layer of said at least one rigid subassembly and the interior conductor layer of said flexible subassembly being electrically connected to each other.

2. A magnetic resonance reception coil as claimed in claim 1 wherein said at least one rigid subassembly comprises a first housing and a second housing that are connected to each other to form said at least one rigid subassembly.

3. A magnetic resonance reception coil as claimed in claim 2 wherein said first housing and said second housing each comprise a cavity, the respective cavities of said first housing and said second housing forming a reception space when said first housing and said second housing are connected together.

4. A magnetic resonance reception coil as claimed in claim 3 wherein said interior conductor layer of said rigid subassembly is disposed within said reception space.

5. A magnetic resonance reception coil as claimed in claim 2 wherein said first housing is connected to said second housing by a connection selected from the group consisting of screw fastening, clamping, bonding and ultrasonic welding.

6. A magnetic resonance reception coil as claimed in claim 1 wherein said rigid subassembly comprises a hard plastic structure.

7. A magnetic resonance reception coil as claimed in claim 1 wherein said at least one flexible subassembly comprises a flexible outer covering, and wherein said interior conductor layer of said at least one flexible subassembly is wrapped within said flexible outer covering.

8. A magnetic resonance reception coil as claimed in claim 7 wherein said flexible outer covering has a plurality of grooves in an exterior surface thereof.

9. A magnetic resonance reception coil as claimed in claim 7 wherein said flexible outer covering is comprised of elastic polymers.

10. A magnetic resonance reception coil as claimed in claim 9 wherein said elastic polymers are selected from the group consisting of artificial elastic plastic compounds and foam plastics.

11. A magnetic resonance reception coil as claimed in claim 7 wherein said flexible outer covering has a shape produced by a process selected from the group consisting of injection molding, casting and hot pressing.

12. A magnetic resonance reception coil as claimed in claim 1 wherein said at least one rigid subassembly and said at least one flexible subassembly are connected together by a connection selected from the group consisting of clamping, insertion, screw fastening and bonding.

13. A magnetic resonance reception coil as claimed in claim 1 wherein said interior conductor layer of said at least one rigid subassembly and said interior conductor layer of said at least one flexible subassembly are electrically connected by an electrical connection selected from the group consisting of welding, riveting, a circlip, and screw fastening.
